(19) United States
(12) Patent Application Publication
(10) Pub. No.: US 2016/0261588 A1
(43) Pub. Date: Sep. 8, 2016

(54) SECURE NFC TOKEN SUPPORTING ESCALATING AUTHENTICATION OF NFC EXCHANGES

(71) Applicant: Tapcentive, Inc., San Francisco, CA (US)

(72) Inventors: Gavin Shenker, Los Angeles, CA (US); David Wentker, San Francisco, CA (US)

(73) Assignee: Tapcentive, Inc., San Francisco, CA (US)

(21) Appl. No.: 15/060,054

(22) Filed: Mar. 3, 2016

Related U.S. Application Data
(60) Provisional application No. 62/128,152, filed on Mar. 4, 2015.

(51) Int. Cl. H04L 29/06

(52) U.S. Cl. CPC H04L 63/0853; H04L 63/0876

(57) ABSTRACT

A secure NFC Smart Card supporting the enablement of escalating authentication is described. The system includes a secure NFC Smart Card comprising two coupled applications. The first application emulates a standard NFC tag returning NDEF messages with the addition of a specific NDEF message including a unique Smart Card identifier and a unique signed token that varies per tap. This unique signed token, when verified, identifies a specific Smart Card and a specific tap. The second application provides a challenge (Profile)/response (signed Token) interaction. This interaction allows a device to present a challenge (Profile) to the second application which will verify the challenge (Profile) and sign a response (signed Token). This signed Token, when verified, identifies a tap occurring with a specific device (provided by the challenge) at a specific Smart Card.

### BACKGROUND

This application claims priority to and benefit of co-pending U.S. Patent Application Ser. No. 62/128,152 filed on Mar. 4, 2015 entitled “SECURE NFC TOKEN SUPPORTING ESCALATING AUTHENTICATION OF NFC EXCHANGES” by Shenker et al., having Attorney Docket No. TAP-006.PRO, assigned to the assignee of the present application, and incorporated herein by reference.

Near field communication (NFC) tags are typically configured to output static data. This static data can compromise one or more NFC data exchange format (NDEF) messages that are intended to initiate specific functions on the device reading the data. Such as, for example, launching an application, navigating to a web page, changing a device setting, and the like. Some of the more sophisticated NFC tags will also include a varying portion of an NDEF message that can be used to uniquely identify a specific tap.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description should not be understood as being drawn to scale unless specifically noted.

FIG. 1 is a block diagram of a secure NFC Smart Card—interacting with an NFC enabled device—supporting escalating authentication exchanges, in accordance with an embodiment.

FIG. 2 illustrates an example of a system for secure NFC smart cards supporting escalating authentication, in accordance with an embodiment.

FIG. 3 illustrates an example of an authentication escalator, in accordance with an embodiment.

FIG. 4 illustrates a flow chart of a method for securing NFC smart cards supporting escalating authentication, in accordance with an embodiment.

FIG. 5 illustrates an example of a type of computer that can be used to implement various embodiments.

### DESCRIPTION OF EMBODIMENTS

Reference will now be made in detail to embodiments of the subject matter, examples of which are illustrated in the accompanying drawings. While the subject matter discussed herein will be described in conjunction with various embodiments, it will be understood that they are not intended to limit the subject matter to these embodiments. On the contrary, the presented embodiments are intended to cover alternatives, modifications and equivalents, which may be included within the spirit and scope of the various embodiments as defined by the appended claims. Furthermore, in the Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Unless specifically stated otherwise as apparent from the following discussions, it is appreciated that throughout the present Description of Embodiments, discussions utilizing terms such as “providing”, “receiving”, “responding”, “verifying”, “challenging”, “generating”, “transmitting”, or the like, often refer to the actions and processes of an electronic computing device/system, such as a desktop computer, notebook computer, tablet, mobile phone, and electronic personal display, among others. The electronic computing device/system manipulates and transforms data represented as physical (electronic) quantities within the circuits, electronic registers, memories, logic, and/or components and the like of the electronic computing device/system into other data similarly represented as physical quantities within the electronic computing device/system or other electronic computing devices/systems.

### Overview of Discussion

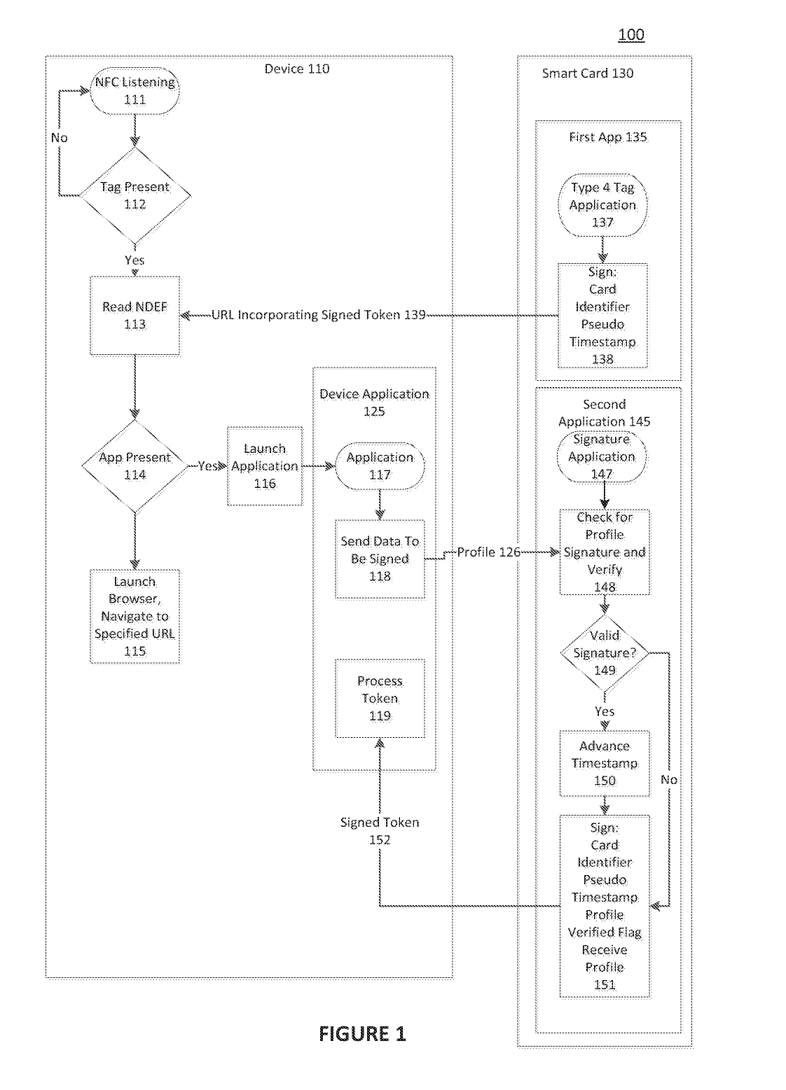

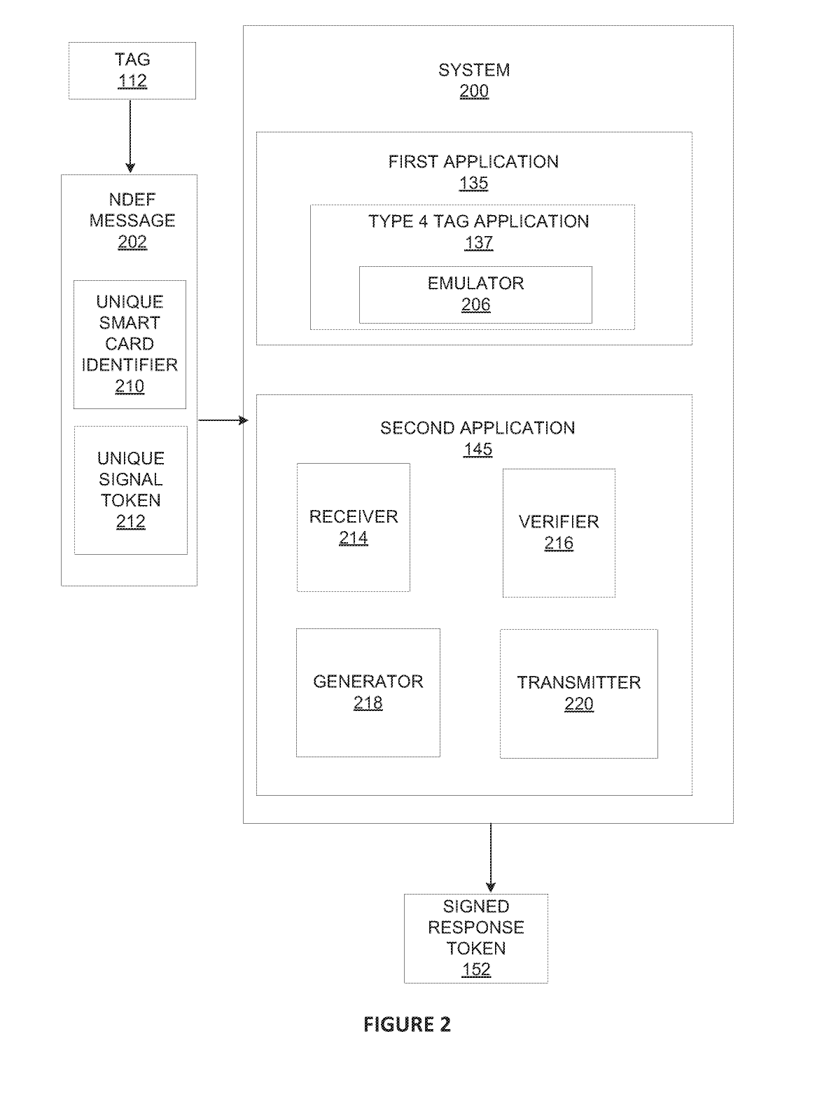

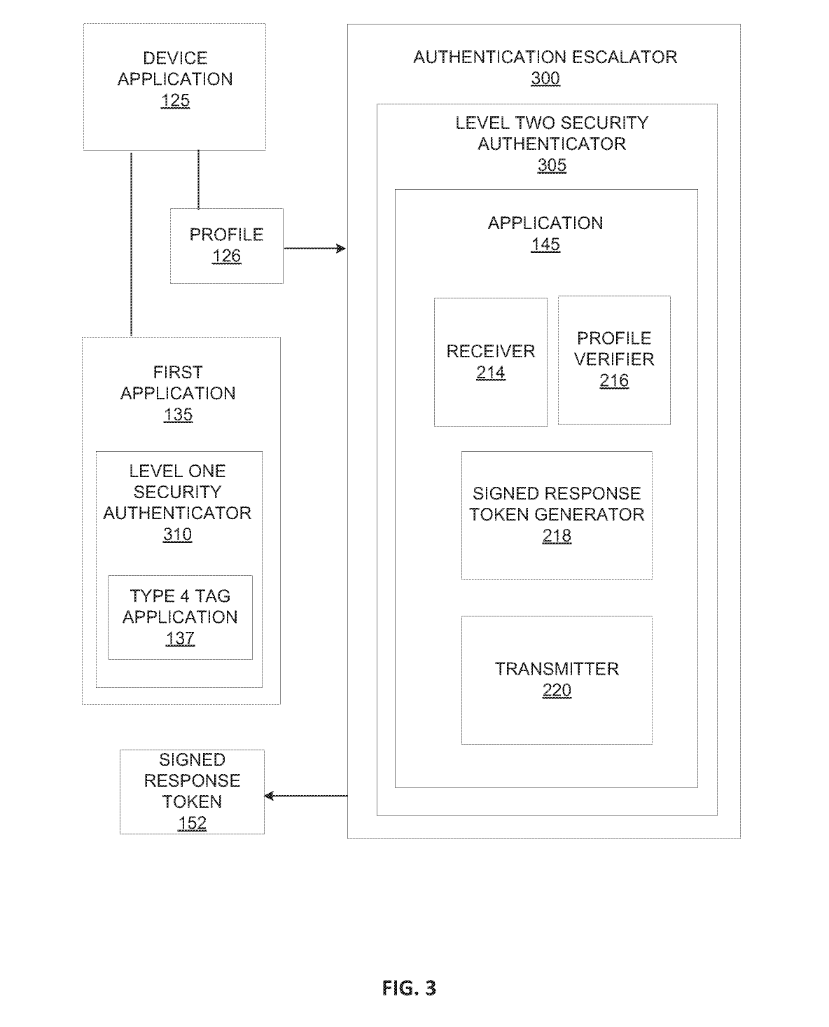

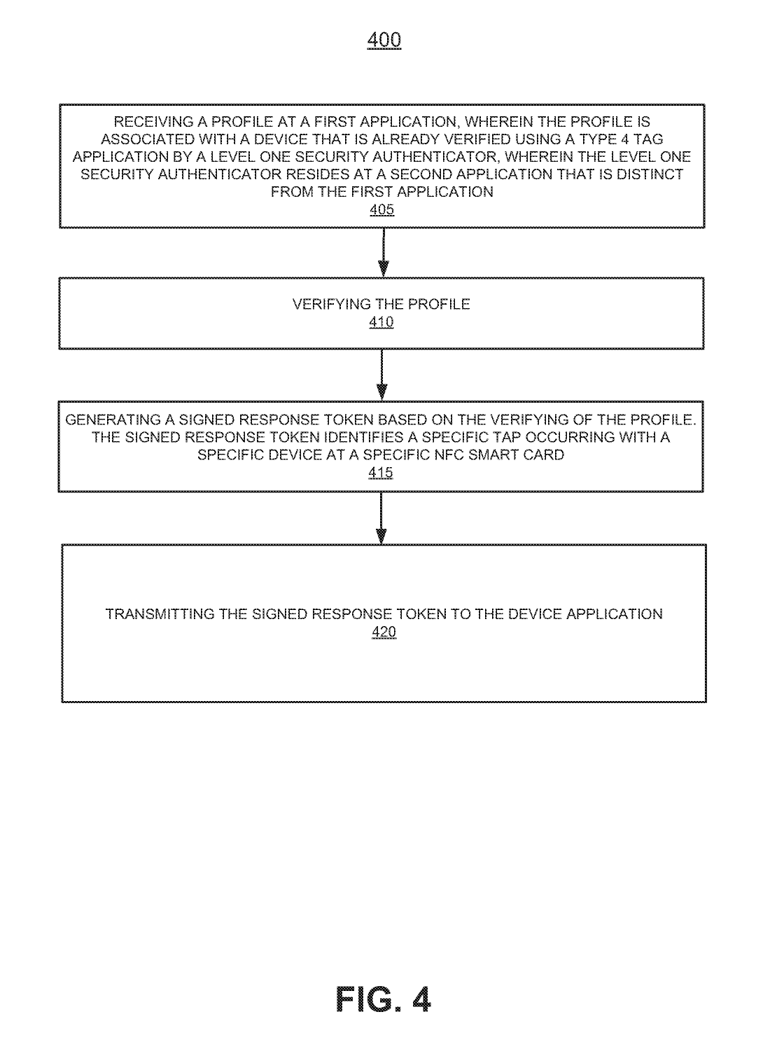

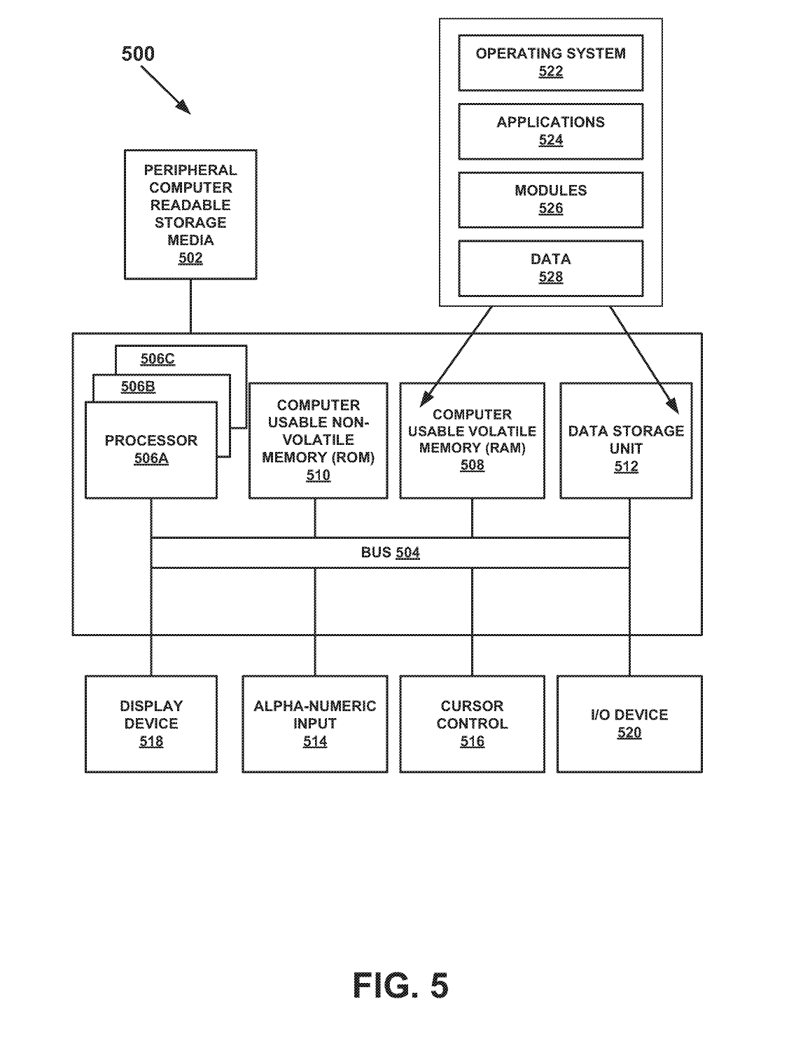

The discussion begins with a brief description of conventional methods for authentication between a smart chip and a mobile device and then describes the difference between conventional methods and the present technology. The discussion continues with a description of FIG. 1, a description of the method and system of performing authentication escalation. The discussion continues with a description of FIGS. 2 and 3, which are block diagrams of embodiments for securing NFC smart cards supporting an escalating authentication. FIG. 4, a flow diagram of a method for supporting escalating authentication, in accordance with an embodiment, is next discussed. Finally, the discussion concludes with a description of an example computer system upon which the example system and methods described herein operate. (See FIG. 5.)

Applications for RFID technologies are increasing rapidly thanks to the creation of the Near Field Communication International technology standard (ISO/IEC 18092) and the associated standardization work by the NFC Forum trade association. The standard has been embraced by mobile phone manufacturers resulting in the inclusion of NFC hardware and capabilities in a broad range of Android, iPhone and Windows Phone models. By including NFC capabilities and exposing the APIs to application developers as has been done on the Android and Windows Phone platforms, applications can be designed to enable phones to read simple NFC chips, or tags. The applications for this interaction between a chip and phone can include topics as diverse as inventory tracking, ticketing, marketing, commerce, security, and the new world of IoT (Internet of Things).

Today there are numerous NFC chips available in the market that provide simple read-only data capabilities. Some of these read-only chips have no authentication capabilities and others like the NXP MIFARE Ultralight EV1 include simple authenticated read capabilities that enable a system, separate from the chip, to verify that data read from a specific chip, originated from that chip. These chips include simple one-way authentication by providing a unique signature on each data string read from the chip.

While one way authentication as described above is useful for many applications, it is not sufficient for applications where there is a need to authenticate the data originating from the chips AND bind that authentication to some element of data from the device (e.g. a mobile phone) interacting with the chip. Furthermore, higher security applications also have a need for the chip to authenticate that the device is allowed to interact with the chip. This combined authentication method enables a system, separate from the chip, to not only verify that data read originated from a specific chip but also verify that it was read by a specific device and that the device is allowed to interact with the chip.

This type of enhanced authentication can be especially useful in applications where it is important to confirm which specific device interacted with a chip. Because the NFC standard is designed to work at a distance of 10 cm or less, this authentication confirms that the device, and the device owner, was within close range of the chip. A simple application to manage hospital rounds where a doctor or nurse touches their phone to an enhanced authentication chip installed in each room of a hospital can help confirm the presence of the doctor's or nurse's phone at each chip location and that only those phones that belong to the doctors and nurses are able to perform the authentication.

There are many smartcard applications in the market that include extensive capabilities for authentication as described above. These applications are typically standalone applications that do not include the ability for a simple interaction that begins with no specialized application and no security, such as is available with NFC chips and the Android Operating System, and then allow that same chip to escalate to an interaction that delivers higher security within a mobile application.

The present invention involves a chip that uses the NFC standard for allowing read-only data that is available to any mobile application that supports the standard, and also includes an interface on the same chip for an increased security interaction that allows the chip to receive data from the reading device, verify that the device is allowed to interact with the chip, and then sign and return the data as described above. The combination on one chip of this read-only capability based on an open standard along with a simple mechanism to increase the security when interacting with the same chip is what we refer to as a Secure NFC Token Supporting Escalating Authentication of NFC Exchanges.

With reference now to FIG. 1, a block diagram of a system 100 for a secure NFC Smart Card 130 supporting an escalating authentication of a device 110 including the ability to enable two applications 135 and 145 on a contactless Smart Card 130 is shown according to an embodiment. In one embodiment, device 110 is a mobile communications device, such as, but not limited to, a smart phone platform, a tablet, and the like.

In one embodiment, the first application 135 conforms to the NFC Forum Type 4 Tag specification and the second application 145 is a proprietary ISO/IEC 14443 challenge (Profile)/response (Signed Token) application.

As individual applications, each application behaves as specified and will interact with any reader/writer device that follows the specification for that device. However when combined with the NFC functionality, such as NFC listening 111, enabled on a device 110, such as a smart phone platforms where NDEF data read 113 from a NFC Forum compliant tag 112 is used by the underlying operating system to initiate specific tasks, this concept enables the process described below.

The NDEF data present in the Type 4 Tag 137 is a URL (with an appended signed token) which in one case, causes the device browser to be launched and directed to the URL present in the NDEF data, and in another case causes a specific application present on the device to be launched.

The latter case described herein is reliant on the specific application 125 being installed on the device 110 and configured to launch based on a specific URL—or piece of a URL—being present in a received NDEF. For example, a mobile communication device, such as an Android™ phone, is tapped against a poster that has a smart chip within. The phone, in one embodiment, has a specific application installed thereon that enables it to communication with the smart chip. The present technology has at least two security levels present. The first security level enables the smart chip and the mobile device to communicate with each other, using NFC standard communication security protocols regarding standard challenge/response methods available in the field of technology.

The present technology adds a second security level working in concert with and following the completion of authentication occurring at the first security level. The second security level serves to further authenticate that the mobile device, and in fact, the device owner, is in fact in close range of the chip and is thus permitted to communicate with the chip. The process performed at the second security level will be described below.

This enhanced, escalated authentication is especially useful in a wide array of applications. For example, a nurse may tap or come into the range of an item containing the smart chip. The smart chip has information that it may communicate to the nurse regarding a particular patient. However, only after the smart chip and the nurse's mobile phone perform the both the first and second level of security does the smart chip release the confidential information regarding the patient to the nurse. This type of escalated authentication features serves to keep the patient information confidential in that the information is only released to those properly identified to receive the information. It is important to note that the nurse's mobile device has an application installed thereon that enables the second layer of security authentication to be performed. In another situation in which the application of more enhanced authentication techniques is necessary is when an employee gets paid hourly for their time on-site at a particular location, such as an orderly at a hospital. The employee is required to make his rounds at a certain time and must visit each patient's room on a particular hospital floor. If the orderly does not visit these rooms, he does not get paid and/or is fired. The orderly is required to use his mobile phone to check in when visiting the rooms.

Currently, there are at least a couple ways that the orderly may communicate that he has visited each patient's room. For example, the orderly may check in remotely via his mobile phone, and never in fact visit the patient's room. Or, the orderly's friend may take the orderly's mobile phone and physically check in at each room.

Embodiments of the present technology provide an escalating authentication feature that circumvents/prevents the orderly from faking a check-in at each patient's room, through one simple swipe/tap of the mobile device. The mobile device second level of authentication is built upon the first standardized level of authentication. The second level of authentication requires an application to be installed on the user's mobile device, along with an application installed on the smart chip, working in concert to authenticate that the mobile phone is in fact that of a particular employee. The application on the mobile phone than enables a time stamp to be recorded of the time of the employee's check in. This prevents a person other than the employee from “checking in” with the smart chip, in that the person must also verify his/her identity in a predetermined process through the application installed on the mobile device. The predetermined process could be anything sort of standard security methods, such as, but not limited to, entering a particular password/code or answering security questions.

As described herein, currently, such an advanced state of security authentication, having at least two levels of authentication, is not available in a single device performing a single tap at/near a smart chip. The present technology enables a host of opportunities for more extensive and/or confidential information to be communicated instantaneously during NFC than is currently available. The mobile device must have an application installed thereon that works in concert with the present technology. If the mobile device taps at/near the smart chip and does not have such an application installed thereon, then in one embodiment, the smart chip causes the mobile device to prompt (via the interface) the user of the mobile device to install a particular application accessible by a particular link. In this manner, the present technology enables laypersons to utilize advanced authentication measures without having to acquire upfront expensive, complicated, and/or separate technology in order to do so. Thus, the mobile communication device is enabled to provide a basic level of authentication security by interacting/using the type 4 tag application installed at the smart chip, and is also enabled to provide advanced, extended authentication security through the combination and cooperation of the device application 125 installed on the device 110, for example, and a second application 145 installed at the smart chip.

The following description is an embodiment of the flow as enabled by the operating system of the device 110 when the targeted device application 125 is not installed on the device 110. In one embodiment, the mobile device selects type 4 tag application 137 from first application 135. The first application 135 then signs a token 139 with a card identifier pseudo timestamp 138. The tag URL incorporating the signed token 139 is provided to the NDEF reader 113 on the device 110. For example, the URL may be a Tapcentive™ URL incorporating the signed token 139.

The NDEF reader 113 reads the NDEF, which in this example is a Tapcentive™ NDEF. At decision block 114, a check for the application 125 being present on the device 110 is performed. (Of note, the device application 125 may be installed entirely on the device 110, may be available at a remote host system [via the Cloud], or a portion of the device application 125 may be installed on the device 110 with the remaining features of the device application 125 available to the device 110 at a remote host system.) For example, in one embodiment, the intent (Android™ specific, whether or not a reference from the URL to an application 125 is present) is based on the received NDEF. For example, when the application 125 is installed on the device 125, the application registers an “intent” with the operating system of the device 110 that indicates that if a particular type of information is presented from the smart chip, this particular type of information is recognized by the application 125 and the application 125 is then launched, such that the application 125 and the second application 145 on the smart chip may cooperate to enable the second level of authentication to be performed.

In one embodiment, if no intent is found to be present, then the process show as element 115 is performed—a browser is launched, wherein the browser navigates to the Tapcentive™ specified URL, at which location the application 125 is available for uploading onto the device 110. For example, if the browser is caused to navigate to the Tapcentive™ specified URL, a message may appear via the interface of the device 110, which recites, for example, “This is Mercy Hospital check-in system. You need this authentication application in order to check-in. Please click HERE to download the authentication application.”

In one embodiment, the server hosting the URL (such as Tapcentive™ hosting a specified URL), can verify the token 139 and alter behavior depending on whether the token 139 is valid, which Smart Card it identifies, whether the token 139 is unique, or if the Pseudo Timestamp in the token 139 has been previously received.

However, in one embodiment if decision block 114 determines that the device application 125 is installed on device 110, then at process labeled as element 116, the device application 125 is launched. In one embodiment, the device application 125 includes one or more of, but is not limited to the following modules: application 117, block 118 that sends profile data to be signed and block 119 which processes signed token 152. In one embodiment, application 117 may be a Tapcentive™ application.

In one embodiment, after the device application 125 is launched, the application 117 will then select the second application 145 on the smart card 130 with which to communicate. For example, the application 117 of the device application 125 sends a request, to the second application 145 of the smart chip, to communication with the second application 145. Thus, with reference to the hospital example, the second application 145 of the smart chip contained within an item in a hospital room includes or is entirely a security application relating to the hospital. The application 125 (e.g., a hospital security application) installed on the device 110 is now able to communicate with the second application 145 (e.g., hospital security application) installed on the smart chip.

In general, the second application 145 is a challenge/response application on the Smart Card 130. At the process denoted as element 118, the data to be signed (e.g., the challenge or Profile data 126) is sent to the Smart Card 130. When the device application 125 is installed on the device 110, the profile 126, an authentication string (or profile signature), is created by the application 125/device 110. The application 125 sends a request to the second application 145, using this authentication string to show that the second application 145 should process the request of device application 125.

In one embodiment, at the element number 148, FIG. 1 shows the second application 145 checking for the profile signature of the profile being sent from the application 117 to the second application 145. The application 117 is sending data 118 to be signed, including a profile 126. The second application 145 finds the profile signature send via the profile 126, and initiates a verification process of the signature. At the element number 149, the second application 145 determines whether or not the profile signature is valid. If the profile signature is not valid, a signed response is generated. At 151, the signed response includes any, but not limited to, the following elements: a card identifier; a pseudo timestamp; a profile verified flag; a received profile. However, of note, this signed response does not include a timestamp, which is added when the profile signature is found to be valid (see description below).

However, if the profile signature is found to be valid, then at the element number 150, the process includes advancing a timestamp such that a valid timestamp is added. That is, the signed token 152 signature includes a card identifier, a pseudo timestamp, a profile verified flag, a received profile, and the like. The signed token 152 is then passed to process token 119 of the device application 125 of device 110.

In general, the process token 119 receives the signed response (e.g., signed token 152) from the smart card 130. The signed token 152 is then verified by a device application 125, which can then alter its behavior depending on any of the following factors: whether the signed token 152 is valid (e.g., which smart card 130 it identifies); the profile 126 identifying a particular device 110 or device user; and whether the signed token 152 is unique (e.g., a signed token had not been previously received by the device application 125); that is, or if the Pseudo Timestamp in the signed token 152 has been previously received.

Thus, in one embodiment, after the tap between the device 110 and the smart card 130, the first application 135 on smartcard 130 triggers the device application 125 on device 110. The device application 125 then interacts with second application 145 on smart card 130. Second application 145 then provides a signed token 152 back to device application 125 on device 110. In so doing, the signed token 152 uniquely links and identifies the device 110 and the specific smart card 130. In contrast to the current technology involving a one-way authentication process (e.g., only proving that the data that is generated is authentic), one embodiment of the present technology provides a two-way authentication system (in areas, for example, involving nonmonetary transactions (communication) of data) that not only proves that the data being generated is authentic, but that the mobile communication device is being utilized by the intended person at the intended location.

FIG. 2 is a block diagram of a system for supporting escalating authentication is described, in accordance with an embodiment. With reference now to FIGS. 1 and 2, a system 200 is shown for securing NFC smart cards that support escalating authentication, in accordance with an embodiment. The system 200 includes the first application 135 and the second application 145. The first application includes the type 4 tag application 137. In one embodiment, the type 4 tag application 137 includes an emulator 206 that emulates a standard NFC tag 112 returning an NDEF message 202 with the addition of a specific NDEF message that includes: a unique smart card identifier 210; and a unique signed token 212. The unique signed token 212 varies per tap. When the unique signed token 212 is verified, it identifies a specific NFC smart car and a specific tap.

The second application 145 includes a receiver 214, a verifier 216, a generator 218 and a transmitter 220, according to an embodiment. In one embodiment, the receiver 214 and the transmitter 220 operate in conjunction with a computer, such as, but not limited to, the computer 500 identified in FIG. 5. The receiver 214 receives a challenge at the second application 145. The verifier 216 verifies the challenge. The generator 218 generates the signed response token 152. When the signed response token 152 is verified, it identifies a specific tap occurring with a specific device at a specific NFC smart car. The transmitter 220 transmits the signed response token 152. In one embodiment, the signed response token 152 is transmitted to the device 110.

FIG. 3 is a block diagram of an authentication escalator 300, in accordance with an embodiment. The authentication escalator will now be described with reference to FIGS. 1-3. The authentication escalator 300 includes the level two security authenticator 305. The level two security authenticator includes the second application 145. The second application 145 includes the receiver 214; the profile verifier 216; the signed response token generator 218; and the transmitter 220.

The level two security authenticator 305 provides a challenge and a response interaction with the device application that resides on the device remote from the application. For example, the level two security authenticator 305 provides a challenge and a response interaction with the device application 125 that resides on the device 110 remote from the second application 145.

The receiver 214 receives a profile at the application, wherein the profile is associated with the device that is already verified using a type 4 tag application by a level one security authenticator. The level on security authenticator resides at a second application that is distinct form the first application. For example, the receiver 214 receives the profile 126 at the second application 145, wherein the profile 126 is associated with the device 110 that is already verified using a type 4 tag application 137 by the level one security authenticator 310. The level one security authenticator 310 resides at the first application 135 that is distinct from the second application 145.

The profile verifier 216 verifies the profile 126.

The signed response token generator 218 generates a signed response token based on the verifying of the profile. The signed response token identifies a specific tap occurring with a specific device at a specific NFC smart card. For example, the signed response token generator 218 generates the signed response token 152 based on the verifying of the profile 126. The signed response token 152 identifies a specific tap occurring with a specific device at a specific NFC smart card.

The transmitter 220 transmits the signed response token 152 to the device application 125.

### Example Operation

The following discussion sets forth in detail some example methods of operation of embodiments. With reference to FIGS. 1-4, the flow diagram of method 400 illustrates an example procedure used by various embodiments. Method 400 includes some procedures that, in various embodiments, are carried out by a processor under the control of computer-readable and computer-executable instructions. In this fashion, procedures described herein and in conjunction with these flow diagrams, alone or in combination, are, or may be, implemented using a computer, in various embodiments. The computer-readable and computer-executable instructions can reside in any tangible computer readable storage media. Some non-limiting examples of tangible computer readable storage media include random access memory, read only memory, magnetic disks, and optical disks, solid-state disks, any or all of which may be employed within a virtualization infrastructure. The computer-readable and computer-executable instructions, which reside on tangible computer readable storage media, are used to control or operate in conjunction with, for example, one or some combination of processors of a virtual machine. It is appreciated that the processor(s) may be physical or virtual or some combination (it should also be appreciated that a virtual processor is implemented on physical hardware). Although specific procedures are disclosed in method 400, such procedures are examples. That is, embodiments are well suited to performing various other procedures or variations of the procedures recited in method 400, alone or in combination. Likewise, in some embodiments, the procedures in method 400, alone or in combination, may be performed in an order different than presented and/or not all of the procedures described in one or more of these flow diagrams may be performed. It is further appreciated that procedures described in method 400, alone or in combination, may be implemented in hardware, or a combination of hardware with firmware and/or software.

FIG. 4 is a flow diagram of the method 400 of providing secure NFC smart cards supporting escalating authentication, in accordance with an embodiment.

With reference not to FIGS. 1-4, step 405 of method 400 includes receiving a profile at a first application, wherein the profile is associated with a device that is already verified using a type 4 tag application by a level one security authenticator, wherein the level one security authenticator resides at a second application that is distinct from the first application. For example, a profile 126 is received at the second application 145, wherein the profile 126 is associated with the device 110 that is already verified using a type 4 tag application 137 by a level one security authenticator 310, wherein the level one security authenticator 310 resides at the first application 135 that is distinct from the second application 145.

Step 410 of method 400 includes verifying the profile. For example, the profile 126 is verified.

Step 415 of method 400 includes generating a signed response token based on the verifying of the profile. The signed response token identifies a specific tap occurring with a specific device at a specific NFC smart card. For example, a signed response token 152 is generated, based on the verifying of the profile occurring at step 410. The signed response token 152 identifies a specific tap occurring with a specific device at a specific NFC smart card.

Step 420 of method 400 includes transmitting the signed response token 152 to the device application 125.

### Example Computer Operating System

With reference now to FIG. 5, all or portions of some embodiments described herein are composed of computer-readable and computer-executable instructions that reside, for example, in computer-usable/computer-readable storage media of a computer system. That is, FIG. 5 illustrates one example of a type of computer (computer system 700) that can be used in accordance with or to implement various embodiments which are discussed herein (See FIGS. 1-4). It is appreciated that computer system 500 of FIG. 5 is only an example and that embodiments as described herein can operate on or within a number of different computer systems including, but not limited to, general purpose networked computer systems, embedded computer systems, routers, switches, server devices, client devices, various intermediate devices/nodes, stand alone computer systems, distributed computer systems, media centers, handheld computer systems, multi-media devices, and the like. Computer system 500 of FIG. 5 is well adapted to having peripheral non-transitory computer-readable storage media 502 such as, for example, a floppy disk, a compact disc, digital versatile disc, other disc based storage, universal serial bus “thumb” drive, removable memory card, and the like coupled thereto.

System 500 of FIG. 5 includes an address/data bus 504 for communicating information, and a processor 506A coupled with bus 504 for processing information and instructions. As depicted in FIG. 5, system 500 is also well suited to a multi-processor environment in which a plurality of processors 506A, 506B, and 506C are present. Conversely, system 500 is also well suited to having a single processor such as, for example, processor 506A. Processors 506A, 506B, and 506C may be any of various types of microprocessors. System 500 also includes data storage features such as a computer usable volatile memory 508, e.g., random access memory (RAM), coupled with bus 504 for storing information and instructions for processors 506A, 506B, and 506C.

System 500 also includes computer usable non-volatile memory 710, e.g., read only memory (ROM), coupled with bus 504 for storing static information and instructions for processors 506A, 506B, and 506C. Also present in system 500 is a data storage unit 512 (e.g., a magnetic or optical disk and disk drive) coupled with bus 504 for storing information and instructions. System 500 also includes an optional alphanumeric input device 514 including alphanumeric and function keys coupled with bus 504 for communicating information and command selections to processor 506A or processors 506A, 506B, and 506C. System 500 also includes an optional cursor control device 516 coupled with bus 504 for communicating user input information and command selections to processor 506A or processors 506A, 506B, and 506C. In one embodiment, system 500 also includes an optional display device 518 coupled with bus 504 for displaying information.

Referring still to FIG. 5, optional display device 518 of FIG. 5 may be a liquid crystal device, cathode ray tube, plasma display device or other display device suitable for creating graphic images and alphanumeric characters recognizable to a user. Optional cursor control device 516 allows the computer user to dynamically signal the movement of a visible symbol (cursor) on a display screen of display device 518 and indicate user selections of selectable items displayed on display device 518. Many implementations of cursor control device 516 are known in the art including a trackball, mouse, touch pad, joystick or special keys on alphanumeric input device 514 capable of signaling movement of a given direction or manner of displacement. Alternatively, it will be appreciated that a cursor can be directed and/or activated via input from alphanumeric input device 514 using special keys and key sequence commands. System 500 is also well suited to having a cursor directed by other means such as, for example, voice commands. System 500 also includes an I/O device 520 for coupling system 500 with external entities. For example, in one embodiment, I/O device 520 is a modem for enabling wired or wireless communications between system 500 and an external network such as, but not limited to, the Internet.

Referring still to FIG. 5, various other components are depicted for system 500. Specifically, when present, an operating system 522, applications 524, modules 526, and data 528 are shown as typically residing in one or some combination of computer usable volatile memory 508 (e.g., RAM), computer usable non-volatile memory 510 (e.g., ROM), and data storage unit 512. In some embodiments, all or portions of various embodiments described herein are stored, for example, as an application 524 and/or module 526 in memory locations within RAM 508, computer-readable storage media within data storage unit 512, peripheral computer-readable storage media 502, and/or other tangible computer-readable storage media.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments may be combined. Although some embodiments have been described in a language specific to structural features and/or methodological acts, it is to be understood that the subject matter defined is not necessarily limited to the specific features or acts described above. Rather, the specific features and acts described above are disclosed by way of illustration and as example forms of implementing any claims and their equivalents.

What we claim is:

1. A system for secure NFC Smart Cards supporting escalating authentication, said system comprising:
a first application, said first application configured to emulate a standard NFC tag returning an NDEF message with the addition of a specific NDEF message comprising:
a unique Smart Card identifier; and
a unique signed token that varies per tap, said unique signed token, when verified, identifies a specific NFC Smart Card and a specific tap; and
a second application, the second application configured to provide a challenge and a response interaction, said interaction comprising:
a receiver to receive a challenge at said second application;
a verifier configured to verify said challenge; and
a generator to generate a signed response token, said signed response token, when verified, identifies a specific tap occurring with a specific device at a specific NFC Smart Card:
a transmitter to transmit said signed response token.

2. An authentication escalator comprising:
a first application comprising a level two security authenticator, said level two security authenticator for providing a challenge and a response interaction with a device application that resides on a device remote from said first application, said first application comprising:
a receiver for receiving a profile at said first application, wherein said profile is associated with said device that is already verified using a type 4 tag application by a level one security authenticator, wherein said level one security authenticator resides at a second application that is distinct from said first application;
a profile verifier for verifying said profile;
a signed response token generator for generating a signed response token based on said verifying of said profile, wherein said signed response token identifies a specific tap occurring with a specific device at a specific NFC Smart Card; and
a transmitter for transmitting said signed response token to said device application.
